(19) United States
(12) Patent Application Publication
(10) Pub. No.: US 2012/0302201 A1
(43) Pub. Date: Nov. 29, 2012

(54) METHODS AND ARRANGEMENTS FOR SUPPORTING POSITIONING

(75) Inventors: Iana Siomina, Solna (SE); Torbjörn Wigren, Uppsala (SE)

(73) Assignee: Telefonaktiebolaget L M, Stockholm (SE)

(21) Appl. No.: 13/518,258

(22) PCT Filed: Dec. 9, 2011
(86) PCT No.: PCT/SE11/51500

§ 371 Date: Jun. 21, 2012

Related U.S. Application Data
(60) Provisional application No. 61/424,755, filed on Dec. 20, 2010.

(51) Int. Cl. H04W 4/14; G10L 15/26; H04W 4/22

(52) U.S. Cl. 455/404.2; 455/466

(57) ABSTRACT

There is provided a polyamic acid resin composition, a method for preparing the same and a polyimide metal clad laminate using the same, in which the polyamic acid resin composition includes an epoxy compound represented by Chemical Formula 1 is defined in specification.

### TECHNICAL FIELD

This invention in general relates to supporting positioning in wireless communications networks, and in particular methods and arrangements for supporting positioning based on text-based message communication between a user and a network node.

### BACKGROUND

In a typical cellular radio system, wireless terminals communicate via a radio access network to one or more core networks. The wireless terminals can be mobile stations or user equipment units (UE) such as mobile/cellular telephones and laptops with wireless capability, and thus can be, for example, portable, pocket, hand-held, computer-included, or car-mounted mobile devices which communicate voice and/or data via a radio access network.

Emergency positioning, e.g., positioning for E-911 calls in North America or 112 in Europe, is a regulatory requirement in the United States. Currently emergency positioning is typically triggered by the setup of an emergency call, e.g., someone dialing the emergency number, 911 in the previous example, on a cell phone. A voice communication between the user and the Public Safety Answering Point (PSAP) is then setup.

Such an emergency service is not feasible for, e.g., people with speech disabilities. Furthermore, there is also a problem in cases where the 911 call is placed in situations in which the cell phone user is under threat and voice communication with PSAP agents is not possible. In fact, such situations may prevent users from dialing 911 to get assistance from, e.g., the police or other law enforcement or medical emergency personnel. These problematic issues with current emergency type services have also been recently realized by regulatory bodies, which have initiated discussions on possible network solutions.

There is thus a need for silent or stealthy ways for users to place 911 calls. One such way could be to send an emergency short message service (SMS) or using another text messaging service. A number of problems occur with or are associated with prior art solutions since there is no standardized way to prevent the PSAP to contact the caller without setting up an E-911 voice call. This is currently under discussion in 3GPP, in particular control plane solutions. In case the user lacks voice communication capability, as may be the case when the user equipment consists of a laptop or in a case with a user with disabilities, no E-911 communication opportunity exists for the PSAP and emergency positioning is thus not possible. Furthermore, there are no means to ensure language consistency between the sending and receiving sides, and also between the emergency message language and the positioning information language.

There is also a need for silent or stealthy ways for users to place commercial calls. One such way could be to send a commercial short message service (SMS) or a text messaging. A number of problems occur with or is associated with prior art solutions since there is no standardized way to avoid that the commercial service provider contacts the caller without setting up a voice call. In case the user lacks voice communication capability, as may be the case when the user equipment consists of a laptop or in a case with a user with disabilities, no communication opportunity exists for the commercial service provider and positioning is thus not possible. Furthermore, there are no means to ensure language consistency between the sending and receiving sides, and also between the text message language and the positioning information language.

### SUMMARY

The object of the present invention is to address some of the problems and disadvantages outlined above, and to support positioning based on text-based message communication between a user and a network node. This object and others are achieved by the methods and arrangements according to the independent claims, and by the embodiments according to the dependent claims.

In accordance with a first aspect of embodiments, a method in a first node of a wireless communication system, of supporting positioning of a UE is provided. The method comprises transferring a text-based message with location information between the control plane of the first node and the user plane of the first node. It further comprises sending or receiving the text-based message with location information over the user plane to or from a second node of the wireless communication system.

In accordance with a second aspect of embodiments, a method in a location services (LCS) client of a wireless communication system, of supporting positioning of a UE, controlled by a routing node comprised in the wireless communication system is provided. The method comprises receiving a text-based message with location information from the UE over the control plane via the routing node. It further includes sending a request for positioning of the UE to a positioning node comprised in the wireless communication system and sending a response message over the control plane to the routing node. Moreover, the method comprises receiving a positioning location of the UE from the positioning node.

In accordance with a third aspect of embodiments, a method in a positioning node of a wireless communication system, of supporting positioning of a UE, associated with a LCS client comprised in the wireless communication system is provided. The UE is controlled by a routing node comprised in the wireless communication system. The method comprises receiving a text-based message with location information from the UE over the control plane via the routing node and receiving a request for a positioning of the UE from the LCS client. It further includes retrieving UE location capability information and initiating positioning of the UE based on the UE location capability information. The method further comprises producing positioning of the UE and sending positioning of the UE to the LCS client.

In accordance with a fourth aspect of embodiments, an arrangement in a first node of a wireless communication system, of supporting positioning of a UE is provided. The arrangement comprises a processing unit adapted to transfer a text-based message with location information between the control plane of the first node and the user plane of the first node, and a transceiver unit adapted to send or receive the text-based message with location information over the user plane to or from a second node of the wireless communication system.

In accordance with a fifth aspect of embodiments, an arrangement in a LCS client of a wireless communication system, of supporting positioning of a UE, controlled by a routing node comprised in the wireless communication system is provided. The arrangement comprises a transceiver unit adapted to receive a text-based message with location information from the UE over the control plane via the routing node. It is further adapted to send a request for positioning of the UE to a positioning node comprised in the wireless communication system, and to send a response message over the control plane to the routing node. The transceiver unit is further adapted to receive a positioning location of the UE from the positioning node.

In accordance with a sixth aspect of embodiments, an arrangement in a positioning node of a wireless communication system, of supporting positioning of a UE, associated with a LCS client comprised in the wireless communication system is provided. The UE is configured to be controlled by a routing node comprised in the wireless communication system. The arrangement comprises a transceiver unit adapted to receive a text-based message with location information from the UE over the control plane via the routing node. The transceiver unit is further adapted to receive a request for a positioning of the UE from the LCS client. The arrangement further comprises a processing unit adapted to retrieve UE location capability information and to initiate positioning of the UE based on the UE location capability information. Moreover, the processing unit is further adapted to produce positioning of the UE. Additionally, the transceiver unit is adapted to send positioning of the UE to the LCS client.

An advantage of particular embodiments is that they provide non-voice communication means, e.g., SMS or other messaging service, to become a part of the communication media that can be used between a UE and a LCS client for stealthy positioning which, firstly, allow users with speech disabilities to contact LCS clients and get the service, including positioning which is normally conducted for voice calls. Thus, they allow users without any voice connection, e.g., users using laptops, to be positioned.

Another advantage of particular embodiments is that they provide non-voice communication means, e.g., SMS or other messaging service, to become a part of the communication media that can be used between UE and PSAPs for stealthy E-911 positioning which, firstly, allow users with speech disabilities to contact PSAPs and get the emergency service, including positioning which is normally conducted for E-911 calls. Secondly, they allow users to contact PSAPs in threatening situations without getting detected due to audio traffic. Thirdly, they allow users to be positioned in threatening situations without getting detected due to audio traffic. Finally, they allow users without any voice connection, e.g., users using laptops, to be positioned in threatening situations.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1-FIG. 4 are diagrammatic views of differing interfaces and functionalities comprising a UE according to non-limiting example embodiments.

FIG. 5-FIG. 10 are diagrammatic views of differing interfaces and functionalities comprising a routing node according to non-limiting example embodiments.

FIG. 11-FIG. 12 are diagrammatic views of differing interfaces and functionalities comprising an eSMLC node according to non-limiting example embodiments.

FIG. 13-FIG. 14 are diagrammatic views of differing interfaces and functionalities comprising a PSAP node according to non-limiting example embodiments.

FIG. 15 illustrates a diagrammatic view of signaling for a text-based message according to a non-limiting example embodiment.

FIG. 16 is a flowchart illustrating an exemplary embodiment of a method in a node of a wireless communication system, e.g., a UE or a routing node.

FIG. 17 is a flowchart illustrating an exemplary embodiment of a method in an LCS client of a wireless communication system.

FIG. 18 is a flowchart illustrating an exemplary embodiment of a method in a positioning node of a wireless communication system.

FIG. 19-FIG. 20 are schematic views of network configurations wherein the technology disclosed herein may be utilized.

FIG. 21 is a block diagram of an exemplary embodiment of an arrangement in a node of a wireless communication system, e.g., a U or a routing node.

FIG. 22 is a block diagram of an exemplary embodiment of an arrangement in a LCS client of a wireless communication system

FIG. 23 is a block diagram of an exemplary embodiment of an arrangement in a positioning node of a wireless communication system.

### DETAILED DESCRIPTION

In the following description, for purposes of explanation and not limitation, specific details are set forth such as particular architectures, interfaces, techniques, etc. in order to provide a thorough understanding of the disclosed embodiments. However, it will be apparent to those skilled in the art that the disclosure may be practiced in other embodiments that depart from these specific details. That is, those skilled in the art will be able to devise various arrangements which, although not explicitly described or shown herein, embody the principles of the embodiments and are included within its spirit and scope. In some instances, detailed descriptions of well-known devices, circuits, and methods are omitted so as not to obscure the description with unnecessary detail. All statements herein reciting principles, aspects, and embodiments, as well as specific examples, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Both in the United States and in Canada there is interest in using short message service (SMS) or text-based services for stealthy emergency “conversations” between UEs and Public Safety Answering Points (PSAPs). One of the objects of the embodiments disclosed herein is to provide Location Services (LCS) support for non-voice emergency, e.g., SMS or other text based messaging, also covering the case when the latter is used for emergency communications. In one of its aspects the technology disclosed herein includes UE-oriented technology utilizing the user plane of the radio access network (RAN), targeting mainly emergency communication, although not limited to the emergency case only.

In the following an exemplary embodiment of an emergency, e.g., E-911 or 112, case is disclosed covering details of an emergency non-voice communication session and emergency positioning, over the user plane.

In a more general exemplary embodiment, the functionality of the PSAP is replaced by a commercial positioning service provider node or more generally non-emergency positioning service provider node. A LCS Client may reside in such a node. The latter may also be, e.g., a node with a network management functionality such as Self Organizing Network (SON), Minimizing Drive Tests (MDT), etc. In some of its aspects, the technology disclosed herein encompasses node technology, including the UE, a routing node, a positioning node, and the PSAP or LCS client.

As used herein, the term UE is used as a general term for a wireless device or wireless terminal which may or may not necessarily support circuit switched (CS) voice and where the device may be a mobile, a laptop, a PDA, a user terminal, etc. In the user plane, UEs, according to the definition above, are referred to as SUPL Enabled Terminals (SETs).

Although the example embodiments of the technology disclosed herein are mainly described for E-911 used in North America, it can be understood that they can be extended to other voice-based emergency services, e.g., 112 in Europe, etc. Similarly, the non-voice emergency service is referred to as E-911 SMS, which shall be understood herein in a more general sense: non-voice based emergency service. Also, most of the embodiments, for the sake of convenience, are described for SMS. However, the technology disclosed herein is not limited to SMS but apply with any text-based or non-voice communication service in general. Thus, the term SMS is used herein as a general term to describe example embodiments of the technology disclosed herein for SMS and non-SMS text-based messaging services in general, e.g., the embodiments of the technology disclosed herein may also be used with any other messaging service, e.g., Enhanced Messaging Service (EMS), Multimedia Messaging Service (MMS), Instant Messaging (IM), any text-based messaging, where any of the listed can be real-time or non-real-time, session-based or session-less. With this generalization, when SMS is mentioned herein, the prior are architecture for SMS service is not necessarily assumed for the disclosed solutions, i.e. it may also be subject to changes according to the embodiments of the technology disclosed herein.

The positioning node in Long Term Evolution (LTE) may be, e.g., an evolved Serving Mobile Location Center (eSMLC) (also known as an E-SMLC) or SUPL Location Platform (SLP) in the control and user plane, respectively. The location center of SUPL-enabled positioning platform (SLP) may be integrated with the eSMLC or may have a proprietary interface to it. Unless the node is explicitly stated, either of the positioning node types are envisioned according to the technology disclosed herein.

The description of the technology disclosed herein primarily focuses on LTE. However, the embodiments can be generalized and adapted for other Radio Access Technologies (RATs), single- or multi-RAT systems. Examples of other technologies are WCDMA and GSM. An example of multi-RAT positioning system implementation is a system wherein a positioning node is capable of multi-RAT positioning and such a node may also be used as a positioning node in the following described embodiments. The herein used term eNodeB refers to a radio base station in general, which can be an LTE radio base station, e.g., eNodeB, femto/home eNodeB, pico or micro base station, relay, etc., a radio base station of another radio access technology, a multi-RAT or multi-standard radio base station, etc.

As used herein, a routing node may be any node with a functionality that allows for receiving an SMS and transmitting it further to the positioning node. Such a routing node may be a standalone node (e.g., a router, a gateway, switching center, etc.) or a node integrated with another node (e.g., with a positioning node) or a node which has a proprietary interface with another node (e.g., with a positioning node) or be a functional block in a more general node (e.g., LTE gateway, femto/home eNodeB Gateway). In one exemplary embodiment, a routing node is operating in a network with multiple RATs and is equipped with interfaces to more than one packet switched (PS) network that relates to more than one RAN. In one embodiment, the routing node has at least one interface to a CS network.

A Public Safety Answering Point (PSAP) node as used herein may or may not be the same PSAP used for voice-based emergency service. In at least one embodiment, the PSAP node used for non-voice based emergency service (also referred herein as E-911 SMS) is different from that used for the voice-based emergency communication PSAP.

A non-limiting example of the user plane solution is OMA SUPL (Open Mobile Alliance Secure User Plane Location). Furthermore, connections and links between any two nodes discussed in the following description may imply either a direct connection or a connection via multiple nodes.

There is no cellular support that allows users to contact PSAPs in a stealthy way, without placing a voice call in prior-art technology. In particular there is no support for emergency communication which not voice-based (e.g., for E-911 SMS or other emergency text-based messaging), neither over the control plane or the user plane of the RAN. With a new type of emergency services, it may be not sufficient with a single Client Type for emergency services since this Client Type is used in the prior art for voice-based emergency communication. Furthermore, with a new type of emergency service, it may be not sufficient with the prior-art set of Service types defined for emergency (Public Safety Services: Emergency Services and Emergency Alert Services). In case of stealthy user plane emergency, e.g., E-911, calls and positioning there is no way for transferring information from the E-911 functionality of the UE (that may also be a UE without voice communication capability). Moreover, there is no way for signaling the emergency, e.g., E-911, information over the user plane of the RAN, e.g., using an SMS or a text messaging. There is no way for transferring the message from the user plane of the RAN to the communication plane used for emergency, e.g., E-911, communication, e.g., used for communication between the positioning node and PSAP. Furthermore, there is no way for initiating and effectuating emergency positioning in response to a non-voice emergency communication, e.g., E-911 SMS. For example, when SMS is sent to 911, the corresponding PSAP needs to get an identification associated with the subscription such as the Mobile Station International Subscriber Directory Number (MSISDN) and the serving cell information (same as in E911 Phase 1 from CS calls).

There is no cellular support that allows the PSAPs to contact UEs in a stealthy way, without placing a voice call in prior-art technology. In particular, there is no routing functionality that transfers the message from the PSAP, e.g., SMS, on to the UE over the user plane of the RAN and no UE internal interface that is able to transfer the message, e.g., SMS, from the user plane functionality of the UE to the E-911 functionality of the UE, for display.

In case a voice connection is not setup, and a user plane emergency, e.g., E-911, stealthy PSAP call is initiated, the positioning node needs to be informed about the UE positioning capabilities and preferences in prior-art technology. However, today, there is no such signaling of positioning capabilities over the user plane. It can be noted that Cell Identity (Cell ID), Assisted Global Navigation Satellite System (A-GNSS) and Time Advance (TA) based positioning can at least be used over the user plane since the corresponding information is available in the terminal, and can be signalled over the user plane. On top of that the positioning node should be able to utilize such positioning measurements as Observed Time Difference Of Arrival (OTDOA) Reference Signal Time Differences (RSTD), Uplink Time Difference Of Arrival (UTDOA) measurements, eNodeB rx-tx or Angle of Arrival (AoA) (e.g., in case a separate antenna arrangement is in place or when using pre-coding indices), since none of these measurements should require a voice call and the positioning accuracy may be greatly improved by having this possibility.

PSAP needs the ability to send Mobile Terminated Location Request (MT-LR) with emergency Client Type and specified Quality of Service (QoS) to get higher accuracy than that obtained with, e.g., CID, in prior-art technology. This is not in place for stealthy emergency communication today.

Language aspects have to be addressed and are especially challenging with roaming in prior-art technology. Since PSAP or more generally, LCS Clients, have not been considered so far as a part of, e.g., the SMS architecture and there is no means to ensure the language consistency in the stealthy emergency communication in the prior art. For example, UE and PSAP need to communicate in the same language. The location information representation may also be language-dependent, e.g., when civic addresses are used, so there is also a need to ensure the language consistency between the location information and stealthy communication means, e.g., emergency SMS or non-voice communication means in general, which is currently missing in the prior art. For example, eSMLC and PSAP need to communicate in the same language.

The technology disclosed herein concerns embodiments of arrangements and methods providing signaling means and functionality, in a wireless terminal e.g., UE, a routing node, an LCS client and a positioning node, that allows the UE to perform the following disclosed herein. Firstly, it allows the UE to access a user plane signalling functionality via a novel UE internal interface, from the calling functionality, e.g., E-911 service, of the UE. Secondly, it allows the UE to transmit a text-based message, e.g., an emergency text message such as E-911 SMS, over the user plane of the RAN, further on to the LCS client or PSAP or other node(s) with a similar functionality. Thirdly, it allows the UE to receive a response message from LCS client or the PSAP, over the user plane of the RAN to the UE. Further, it allows the UE to transfer the received response message from the user plane functionality of the UE, to the control plane functionality of the UE, e.g., the E-911 functionality of the UE, via the novel UE internal interface. Additionally, it allows the UE to display said response message on the screen of the UE. Lastly, it allows the UE to ensure language consistency during the communication and also with the positioning information language.

In accordance with some aspects of the technology disclosed herein it is not necessary that the information carrying entity be a short message service (SMS). Indeed, other information carrying entities are possible as well, text messaging being just one non-limiting example. Another non-limiting example is messaging which includes objects of more than one type, including graphics. Furthermore, the disclosed example embodiments are also generalized for commercial services, e.g., not limited only to the emergency service.

In the following description a UE-based solution approach for stealthy SMS-triggered positioning is disclosed. In the disclosed exemplary embodiments the SMS format is based on standardized SMS format. Furthermore, the SMS may carry ID information, additional information in the message transmitted or received by the UE and languages information.

The ID information uniquely allows for routing according to the exemplary embodiments described in the following. The ID information amounts to at least one of user ID and user plane switching information. The ID information may carry the information of the SMS from the transmitting UE all the way to the PSAP or LCS client, using the method disclosed in the following. The information may also contain the necessary information for the PSAP/LCS client response to the SMS from the UE.

The SMS may also carry additional information in the message transmitted by the UE or received by the UE. The message may be a written message, which may also be pre-configured. Optionally, the additional information in the message may include an indication of the message language. Moreover, the additional information may include location information. The location information may be some kind of positioning information, e.g., information for identifying what kind of positioning method is supported, a list of supported positioning methods etc. The location information may be the UE capability information or parts of the same. The location information may also comprise civic address information. A text-based message with location information is any message suitable for non-voice communication service in general with location information. Thus, the term text-based message is used herein as a general term to describe example embodiments also be used with messaging service, such as SMS, Enhanced Messaging Service (EMS), Multimedia Messaging Service (MMS), Instant Messaging (IM), any text-based messaging, where any of the listed can be real-time or non-real-time, session-based or session-less.

The transmitted message may include the location information when the civic address information is available, and when it is not available, it may be obtained by triggering positioning, e.g., by triggering a Mobile-Originated Location Request (MO-LR) prior to sending the SMS. The response message may include the available positioning information, upon the availability of the information and upon the need, where the need may be decided by the receiving node based on the contents or the type of the received message transmitted by the UE.

The SMS also carries language information that may be used to ensure that the location information language, e.g., when it is in a civic address format, shall be readable to the receiving node, e.g., the end user or PSAP or a commercial service node such a LCS client. Hence, it shall be transmitted in one of the supported languages of which the positioning node shall be aware or it shall be translated to one of the supported languages. In exemplary embodiments the PSAP/LCS client and positioning node languages may be pre-configured or configured by the Operation and Maintenance (O&M) node, or the positioning node may receive the PSAP/LCS client language indication together with the request or via a capability and/or preferences exchange with it, or the positioning node may receive the UE language together with the request or via a capability and/or preferences exchange with it.

The SMS may also carry language information that may be used to ensure that the response message transmitted to the UE, which may or may not include the location information, shall be in the language understood by the end user, and the transmitted message, which may or may not include the location information, delivered to the receiving node, e.g., PSAP or commercial service node, shall be in the language acceptable at the receiving node. This may be implemented in various ways for example, by default, the responding node, e.g., PSAP or commercial service node, may assume the preferred language to be the one used in the received SMS; the same language may then be used for positioning, or translation applies before transmitting the response message, if the end-user language can be translated to, or translation applies after transmitting the response message, if not in the end-user language, or the location information, if included, shall be consistent with the message language, or the SMS routing node may be a translation point, whilst the message between the SMS routing node and the PSAP or commercial service node may be in a language pre-configured in or configured by O&M or negotiated by or supported by the routing node and PSAP/commercial service node.

In the following exemplary embodiments describing an emergency case are disclosed. They include an extended list of Client Types and Service Types employed to account for the new type of emergency services and the corresponding new signaling. It should be understood that the proposed signalling functionality is one possible exemplary embodiment of which there are many variants. As one example of this, there may be more than one message from the PSAP, to the other involved nodes or UE unit. The embodiments are not limited to LTE only, and apply both to user and control plane.

In the prior art, there is only one Client Type for emergency services. That one Client Type may be not enough when different emergency service types are deployed in the network, e.g., emergency calls and text-based emergency service. It is therefore one exemplary embodiment discloses that the set of prior-art Client Types is extended by at least one new Client Type to account for the new type of emergency services. In another exemplary embodiment, separate Client Types are used for voice-only, text-based, and mixed emergency services. There may also be a separate Client Type for multimedia messaging emergency service.

In another exemplary embodiment, the prior-art set of emergency service types is extended to account for the new type of emergency service, e.g., a new Service Type is defined for text-based, multimedia messaging or mixed emergency services.

At least one of the new Client Types and or Service Types can be signaled, e.g., as a new encoded value of the LCS Client Type or LCS Service Type information elements, along any existing or disclosed herein interface and between the relevant network nodes, directly or via one or more other nodes, between e.g., Mobility Management Entity (MME) and positioning node, eSMLC in the control plane or SLP in the user plane, or eSMLC and SLP, or Positioning node and, Location Measurement Unit (LMU), used for UTDOA, or LCS Client and MME/MSC/GMLC, or GMLC and MME/MSC.

The protocols for the described above interfaces shall then be enhanced with the described new signaling, e.g., LCS Application Protocol (LCS-AP) used between MME and eSMLC, Radio Access Network Application Part (RANAP) over Iu interface in UTRAN.

The new signalled Client Type and/or Service Type information may be used by the received node, e.g., positioning node, for discriminating, e.g., between voice and non-voice emergency services and potentially different prioritization, positioning method selection, etc.

In the following disclosure different nodes are described. It should be noted that not all features in the descriptions below are necessarily needed in all exemplary embodiments.

In one of its aspects, the technology disclosed herein concerns a UE. In a non-limiting exemplary embodiment, the UE comprises a UE interior interface between the E-911 functionality of the UE or the SMS editing functionality and the user plane functionality of the UE that allows the transfer of information, i.e. text of an E-911 SMS or a commercial SMS, from the E-911 functionality of the UE.

The UE further comprises transmission capability of the user plane of the UE for transmission of the text-based message such as the SMS or E-911 SMS over the user plane of the RAN, to a routing node, possibly contained in the positioning node, e.g., the eSMLC in LTE.

The UE further comprises transmission capability from the user plane of the UE for transmission of UE capability information, defining the UE capabilities and/or preferences relevant for positioning, e.g., radio access capabilities, positioning method capabilities, language capabilities, etc., over the user plane of the RAN, to the positioning node, with the message routing information being used to determine the destination of the information and the routing being either over the user plane in association with said transmission of an SMS or E-911 SMS from the UE to the LCS client or PSAP, or over the user plane in response to a request for UE positioning capability from the positioning node.

The UE further comprises UE reception capability over the user plane of the UE, for a response, typically response SMS, from the PSAP or LCS client, in response to said transmitted SMS or E-911 SMS from the UE.

The UE further comprises a UE interior interface between the user plane functionality of the UE and the E-911 functionality of the UE, for transfer of said response SMS from the PSAP or LCS client, for display on the UE screen.

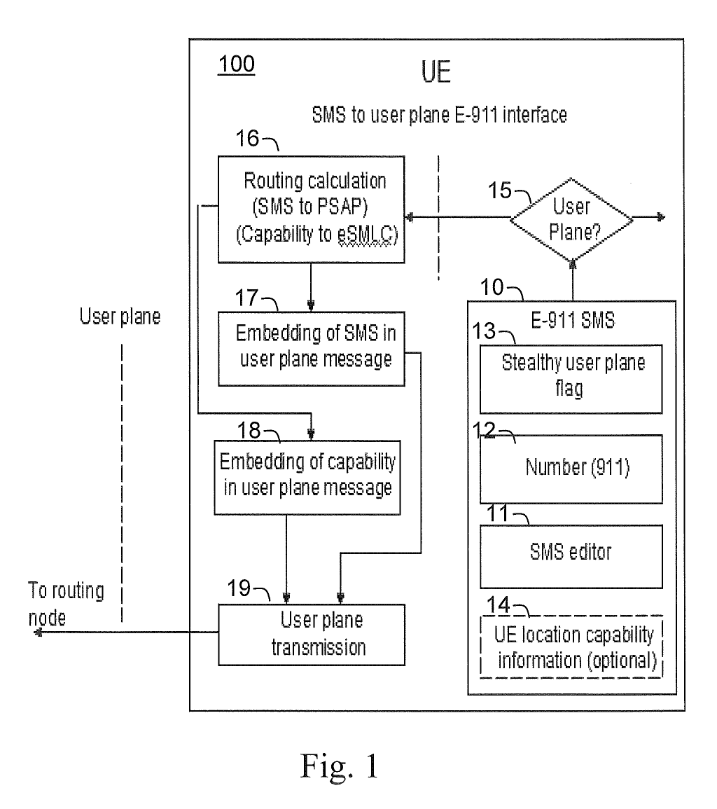

Non-limiting exemplary embodiments of the UE functionality are depicted in FIGS. 1, 2, 3 and 4. As explained below, FIGS. 1-4 show different interfaces and functionalities utilized. In the exemplary embodiments the functionalities illustrated in FIGS. 1-4 may be implemented at least partially on a machine platform including a hardware circuit and/or a computer. The computer-based embodiments comprise a controller or processor executing a set of executable non-transitory instructions stored on computer-readable medium. A UE includes, of course, a communications interface which may comprise a receiver and transmitter in turn connected to one or more antennas.

FIG. 1 shows an exemplary embodiment of a UE 100 illustrating a UE internal SMS to user plane interface and associated functionality for SMS or E-911 SMS transmission. An SMS or E-911 SMS generation functionality 10 in the control plane comprises an SMS editing functionality 11, a number generation functionality 12 and a stealthy user plane flag generation functionality 13 and an optional UE location capability information generation functionality 14. A selection functionality 15 decides whether the generated SMS should be transferred to the user plane or the control plane. In the exemplary embodiment the generated SMS or E-911 SMS is transferred to a routing calculation functionality 16 in the user plane of the UE. The routing of the SMS to the PSAP or LCS client is calculated. Optionally, the routing of the UE location capability information to the routing node is also calculated. Moreover, an SMS embedding functionality 17 is comprised in the UE which provides embedding of the generated SMS in a user plane message. A capability embedding functionality 18 is comprised in the UE which provides embedding of the generated UE location capability information in a user plane message. A user plane transmission functionality 19 is also comprised in the UE providing transmission of the user plane message to the routing node. In FIG. 1, the number generation functionality 12 generates an emergency number, e.g. 911 for the E-911 emergency service. Speech to text conversion may be used for generation of the SMS or emergency E-911 SMS contents. The UE location capability information generated by the optional UE location capability information generation functionality 14 as shown in FIG. 1 is to be interpreted in a wide sense in the detailed description, e.g., as location related capabilities.

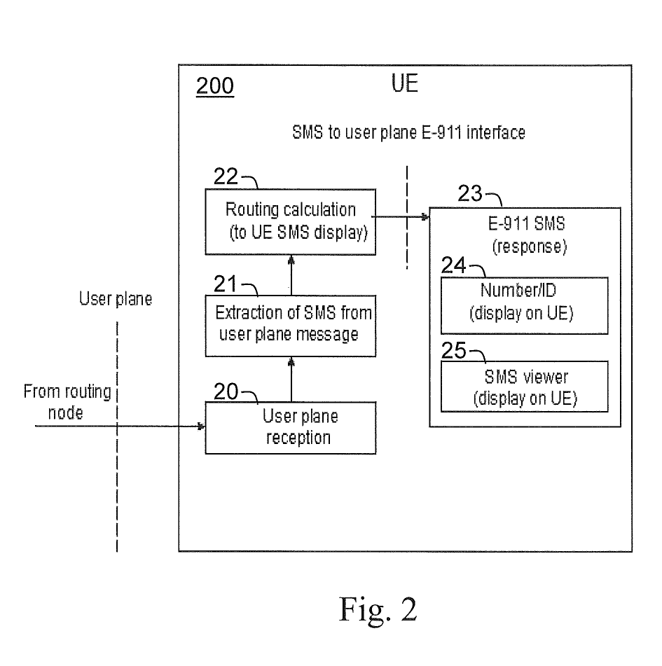

FIG. 2 shows an exemplary embodiment of a UE 200 illustrating a UE internal user plane to SMS interface and associated functionality for response SMS or E-911 response SMS reception. A user plane reception functionality 20 is comprised in the user plane of the UE providing reception of a user plane message from the routing node. An extraction functionality 21 is comprised in the user plane of the UE providing extraction of the response SMS from the received user plane message. Additionally, a routing calculation functionality 22 is comprised in the user plane of the UE providing calculation of the destination of the response SMS or E-911 response SMS. It should be pointed out that the routing calculation is optional. Furthermore, the UE 200 comprises a response SMS or E-911 SMS functionality 23 in the control plane which comprises a number displaying functionality 24 providing displaying of a number or ID of the response SMS and an SMS viewing functionality 25 providing displaying of the response SMS or response E-911 SMS on the UE to the user of the UE.

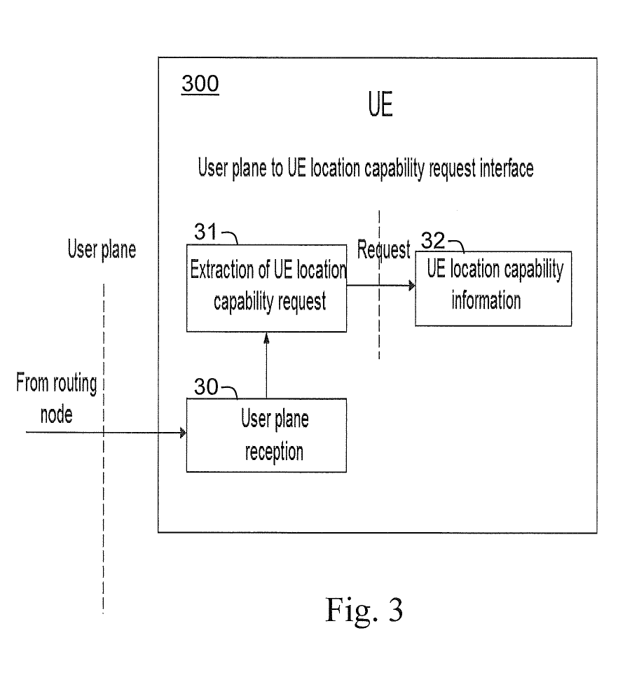

FIG. 3 shows an exemplary embodiment of a UE 300 illustrating a UE internal user plane to UE capability request interface and associated functionality for UE location capability request reception. A user plane reception functionality 30 is comprised in the user plane of the UE providing reception of a user plane message from the routing node. An extraction functionality 31 is comprised in the user plane of the UE providing extraction of a request for UE location capability information from the received user plane message. Furthermore, the control plane of the UE 300 comprises a UE location capability information functionality 32 providing the requested UE location capability information. Also in this embodiment the UE location capability information is to be interpreted in a wide sense in the detailed description, e.g., as location related capabilities.

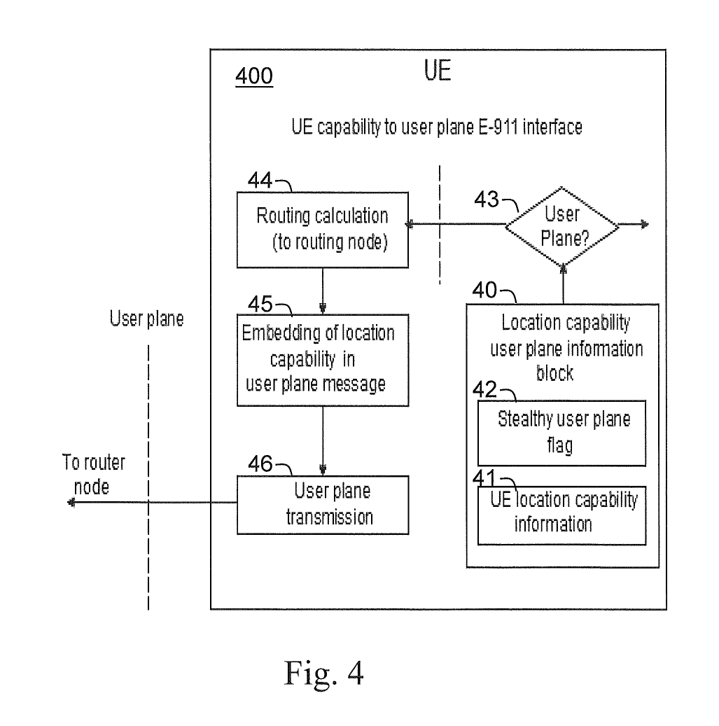

FIG. 4 shows an exemplary embodiment of a UE 400 illustrating a UE capability to user plane interface and associated functionality for UE location capability transmission. A location capability user plane information block 40 in the control plane of the UE comprises a UE location capability information generation functionality 41 and a stealthy user plane flag generation functionality 42. A selection functionality 43 decides whether the generated SMS should be transferred to the user plane or the control plane. In the exemplary embodiment the generated UE location capability information is transferred to a routing calculation functionality 44 in the user plane of the UE. The routing of the UE location capability information to the routing node is calculated. Moreover, a location capability embedding functionality 45 is comprised in the user plane of the UE which provides embedding of the generated UE location capability information in a user plane message. A user plane transmission functionality 46 is also comprised in the user plane of the UE providing transmission of the user plane message to the routing node. Also in this embodiment the UE location capability information is to be interpreted in a wide sense in the detailed description, e.g., as location related capabilities.

In one of its aspects, the technology disclosed herein concerns a routing node. A routing node, as used herein, may possibly be a node which is part of another network node, e.g., the positioning node or the eSMLC node.

In a non-limiting exemplary embodiment of the routing node, the routing node receives user plane SMS or E-911 SMS, and UE capability information from the UE. It further provides an interface that enables transfer of said SMS or E-911 SMS to the control plane and either forwards said SMS or E-911 SMS to the LCS client or PSAP in SMS form according to SMS signaling procedures or E-911 signaling procedures, or uses a text to speech conversion system to convert to audio where the audio version is to be sent over standardized audio communication channels to the LCS client or standardized emergency audio communication channels to the PSAP. Moreover, the routing node sends the UE location capability information to the positioning node, e.g., eSMLC, in order to prepare for the positioning session. Optionally the UE location capability information may be held until after phase 2 positioning session is established in positioning node, e.g., the eSMLC, or be sent in response to a request from the positioning node, e.g., the eSMLC. Note that the message from the routing node to the positioning node, e.g., eSMLC, needs to contain an indicator, possible in the form of a new message, so that the positioning node, e.g., the eSMLC, understands that the location capability information is sent to prepare for an immediate phase 2 positioning session or 2 E-911 positioning session.

In the non-limiting exemplary embodiment of the routing node, the routing node further receives a response from the LCS client or PSAP, over the control plane, either as a response SMS or as an audio response. The routing node provides an interface that enables transfer of the LCS client or PSAP response to the user plane, either by transmitting said response SMS to the user plane or applying speech to text conversion to create a response SMS for the user plane. The routing node transmits the response SMS over the user plane to the UE. Moreover, the routing node may optionally serve as a text translation point.

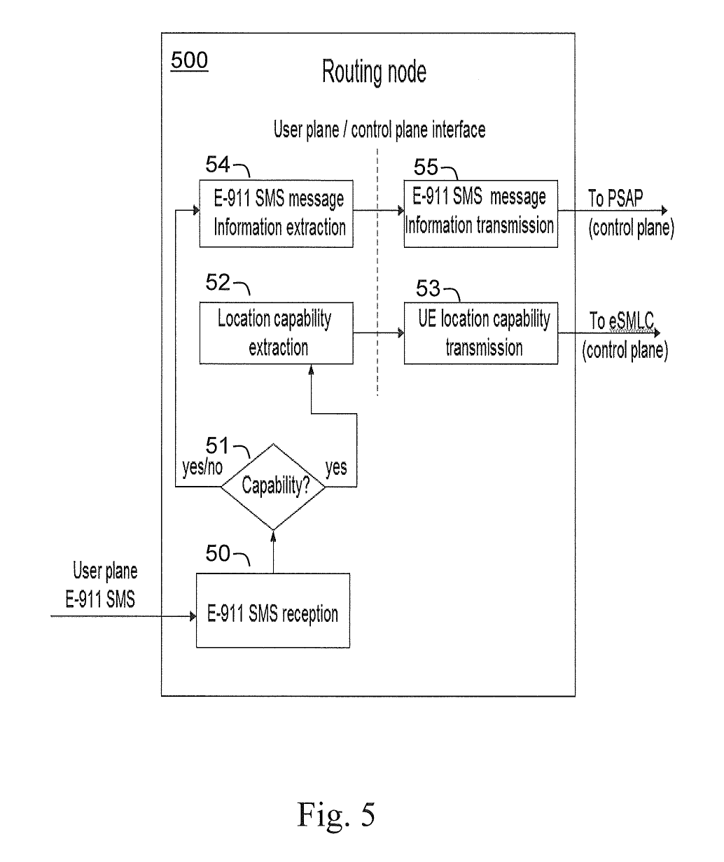

The routing node functionality is depicted by way of exemplary embodiments in FIG. 5-FIG. 10. In an exemplary embodiment the functionalities illustrated in FIG. 5-FIG. 10 may be implemented at least partially on a machine platform including a hardware circuit and/or a computer. The computer-based embodiments comprise a controller or processor executing a set of executable non-transitory instructions stored on computer-readable medium.

FIG. 5 shows an exemplary embodiment of a routing node 500 illustrating a routing node user plane to control plane interface and associated functionality for routing of SMS or E-911 SMS and UE location capability information, and associated capability information, useful for the purpose of the technology disclosed herein. The routing node 500 comprises a SMS or E-911 SMS reception functionality 50 in the user plane which provides for reception of a SMS or E-911 SMS over the user plane from a UE. The routing node comprises a determining functionality 51 which determines whether location capability information is included in the SMS or E-911 SMS received from the UE. If it is included a location capability extraction functionality 52 in the user plane of the routing node provides for extraction of said information and then transfers it via a user plane to control plane interface to a UE location capability transmission functionality. The UE location capability transmission functionality 53 provides for transmission of the UE location capability information to the positioning node, e.g., the eSMLC. The received SMS or E-911 SMS is transferred to a SMS or E-911 SMS message information extraction functionality 54 which provides for extraction of the SMS or E-911 SMS message information from the received SMS or E-911 SMS. Moreover, the extracted SMS or E-911 SMS message information is transferred via the user plane to control plane interface to a SMS or E-911 SMS message information transmission functionality 55 which provides for transmission of said message to the LCS client or PSAP.

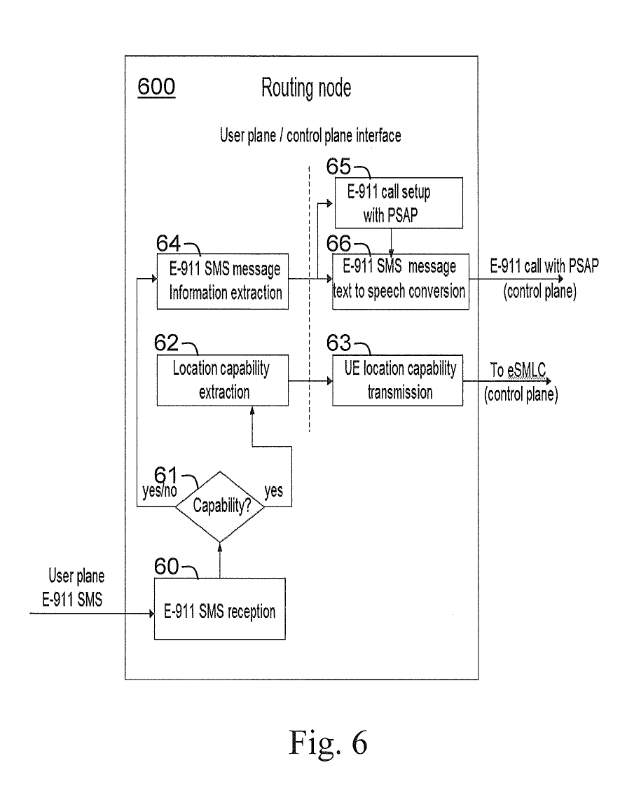

FIG. 6 shows another exemplary embodiment of the routing node 600 illustrating a routing node user plane to control plane interface and associated functionality for text to speech conversion of SMS or E-911 SMS, and routing of UE capability information. The routing node 600 comprises a SMS or E-911 SMS reception functionality 60 in the user plane which provides for reception of a SMS or E-911 SMS over the user plane from a UE. The routing node comprises a determining functionality 61 which determines whether location capability information is included in the SMS or E-911 SMS received from the UE. If it is included a location capability extraction functionality 62 in the user plane of the routing node provides for extraction of said information and then transfers it via a user plane to control plane interface to a UE location capability transmission functionality. The UE location capability transmission functionality 63 provides for transmission of the UE location capability information to the positioning node, e.g., the eSMLC. The received SMS or E-911 SMS is transferred to a SMS or E-911 SMS message information extraction functionality 64 which provides for extraction of the SMS or E-911 SMS message information from the received SMS or E-911 SMS. Moreover, the extracted SMS or E-911 SMS message information is transferred via the user plane to control plane interface to a SMS or E-911 SMS call setup functionality 65 which provides for setting up a call with the LCS client or PSAP. The extracted SMS or E-911 SMS message information is also transferred via the user plane to control plane interface to a SMS or E-911 SMS message text to speech conversation functionality 66 which provides for conversion of said message text to speech, i.e. to an audio version of the message, which is transmitted to the LCS client or PSAP when the call is set up.

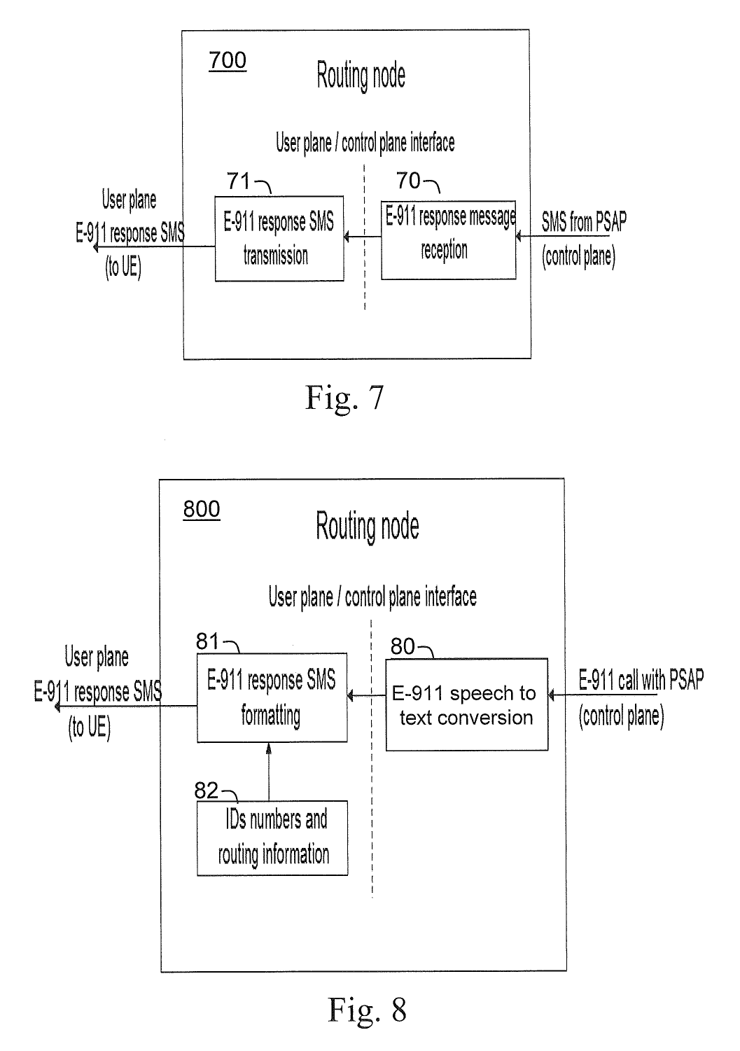

FIG. 7 shows an exemplary embodiment of a routing node 700 illustrating routing of a SMS or E-911 response SMS. The routing node 700 comprises a SMS or E-911 SMS response message reception functionality 70 in the control plane which provides for reception of a SMS or E-911 SMS response message over the control plane from the LCS client or the PSAP. Said message is transferred via the control plane to user plane interface to a SMS or E-911 SMS response message transmission functionality 71 which provides for transmission of said message to the UE over the user plane.

FIG. 8 shows an exemplary embodiment of a routing node 800 illustrating speech to text conversion of a LCS client response or a PSAP E-911 response message into a user plane E-911 response message, as well as transmission of the response message to the UE over the user plane. The routing node 800 comprises a SMS or E-911 SMS message speech to text conversation functionality 80 which provides for conversion of SMS or E-911 SMS response message from speech to text, i.e. to a text version of the response message from the LCS client or PSAP. Said text version of the response message is transferred via the control plane to user plane interface to a SMS or E-911 SMS response message formatting functionality 81 which provides for formatting of said text version of the response message. Moreover, the routing node 800 also includes a functionality 82 which provides the formatting functionality 81 with information such as ID numbers and routing information.

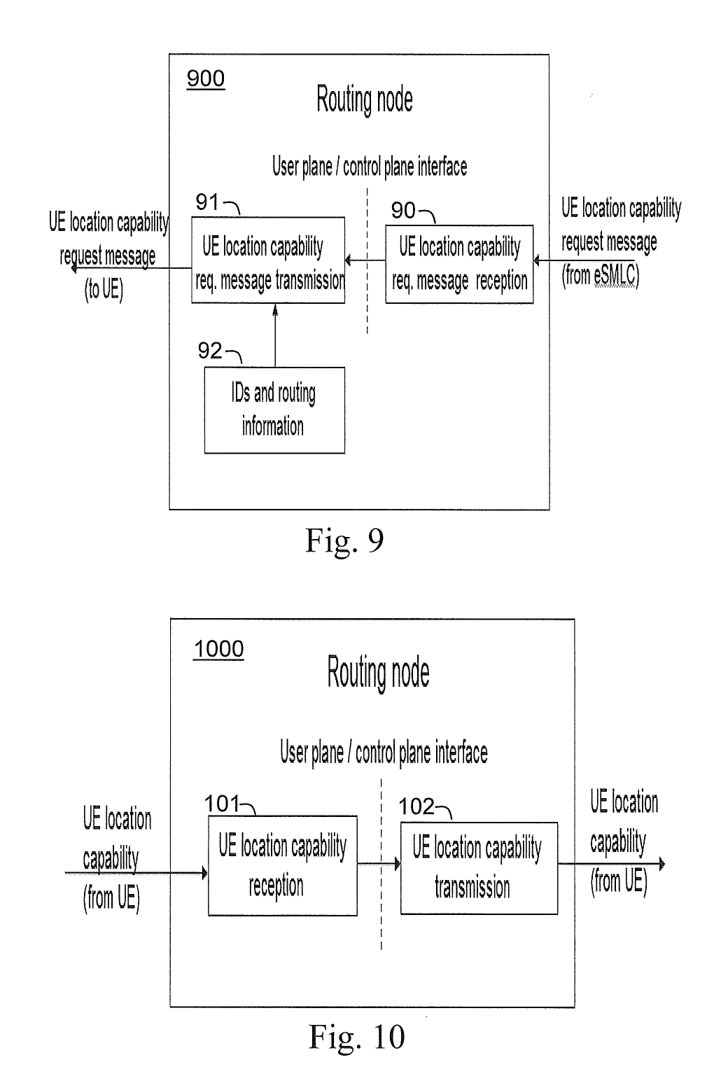

FIG. 9 shows an exemplary embodiment of a routing node 900 illustrating UE location capability request message routing and associated functionality of the routing node. It should be noted that the request message from the positioning node, e.g., the eSMLC, further enhanced with additional information, is an aspect of the technology disclosed herein, and that the UE interface is capable of understanding the novel request message format. The routing node 900 comprises a UE location capability request message reception functionality 90 which receives a UE location capability request message from a positioning node, e.g., a eSMLC over the control plane. Said request message is transferred via a control plane/user plane interface to a UE location capability request message transmission functionality 91 which provides for transmission of the response message to the UE over the user plane. Moreover, the routing node 900 also includes a functionality 92 which provides the transmission functionality 91 with information such as ID numbers and routing information.

FIG. 10 shows an exemplary embodiment of a routing node 1000 illustrating stand alone UE location capability message routing. The routing node 1000 comprises a UE location capability reception functionality 101 which receives UE location capability information from a UE over the user plane. Said information is transferred via a control plane/user plane interface to a UE location capability information transmission functionality 102 which provides for transmission of said information to a positioning node, e.g., a eSMLC, over the control plane.

In one of its aspects, the technology disclosed herein concerns an eSMLC node, possibly including a routing node. In one exemplary embodiment the eSMLC node may receive UE location-related capability information over the user plane, associated with an E-911 SMS. In case the location capability information is received before a positioning session is established, the eSMLC needs to implement new functionality and store the location capability information in memory, which may be internal or external. An indicator or a new type of message which is a part of this disclosure is needed for that purpose. In another embodiment the eSMLC may receive UE location-related capability information from the UE, in response to a request to the UE issued over the user plane. The eSMLC node may further position the UE in response to a request for E-911 positioning from the PSAP and position the UE accounting for said received UE capability information. The eSMLC node may also transmit the position of the UE to the PSAP over standardized interfaces for such signaling.

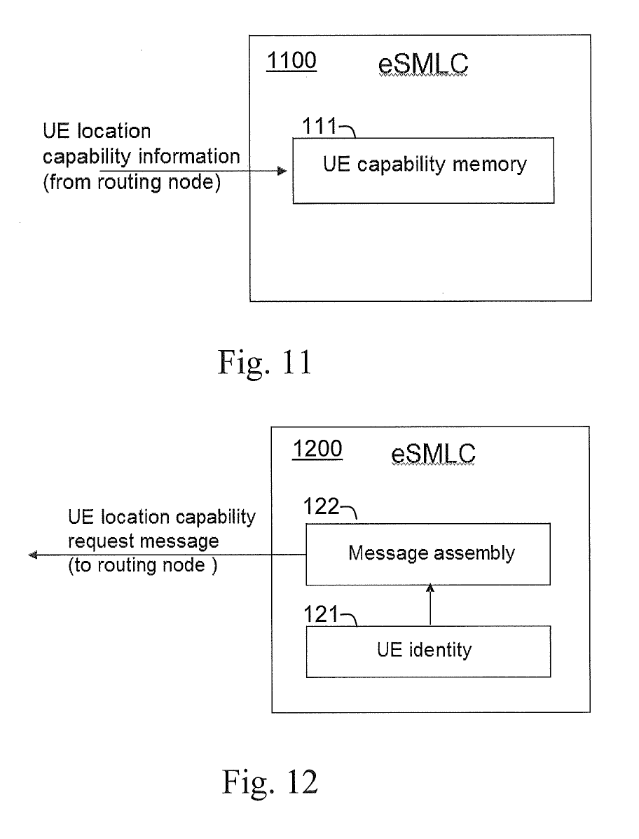

Exemplary embodiments of the eSMLC functionality are depicted in FIGS. 11-12. FIG. 11 shows an exemplary embodiment of an eSMLC node 1100 illustrating UE capability information routed over a user plane from a UE via a routing node and which is stored in the eSMLC. The eSMLC 1100 comprises a UE capability memory 111 in which said information is stored. FIG. 12 shows another exemplary embodiment of an eSMLC node 1200 illustrating UE location capability message assembly and transmission from eSMLC routed over the user plane to the UE via a routing node. The eSMLC 1200 comprises a message assembly functionality 122 which provides for assembly of a UE location capability request message with assistance of a UE identity functionality 121. The message is transmitted to a UE via a routing node.

In an example embodiment the functionalities illustrated in FIG. 11-FIG. 12 may be implemented at least partially on a machine platform including a hardware circuit and/or a computer. The computer-based embodiments comprise a controller or processor executing a set of executable non-transitory instructions stored on computer-readable medium.

In one of its aspects, the technology disclosed herein concerns an E-Public Safety Answering Point (PSAP) node, and particularly a PSAP that receives E-911 SMS information either in SMS form or as a text to speech converted audio signal. Optionally, the PSAP acknowledges to the UE the received E-911 SMS information. Optionally, the PSAP transmits at least one response SMS to the UE. More than one message may be sent, e.g., providing refined position information. The PSAP may further issue a request to position the UE to the eSMLC and may receive the position of the UE from the eSMLC.

The E-911 SMS may contain positioning information collected by positioning functionality of the UE, e.g., an assisted global positioning system (A-GPS) position.

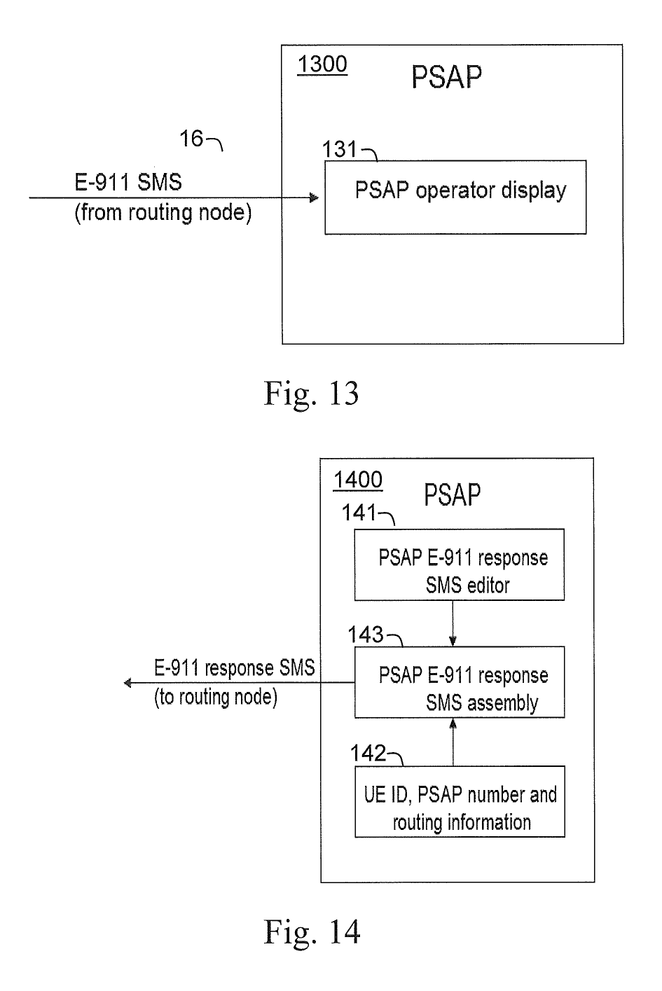

UE measurement and reporting is assumed to follow standard positioning procedures over the user plane. ESMLC positioning is also assumed to follow known procedures, in particular utilizing also methods not available for user plane positioning. In other example embodiments secure user plane location protocol-enabled positioning platform (SLP) procedures known in prior art could also be used to position the UE. Example embodiments of the PSAP functionality are depicted in FIG. 13-FIG. 14. FIG. 13 shows an exemplary embodiment of a PSAP node 1300 illustrating E-911 SMS reception in the PSAP node. The PSAP node 1300 comprises a PSAP operator display functionality 1301 which provides for the display of an E-911 SMS received from a routing node. FIG. 14 shows an exemplary embodiment of a PSAP node 1400 illustrating E-911 response SMS assembly in the PSAP and transmission to the UE via the routing node. The PSAP node 1400 comprises a PSAP E-911 response SMS editor functionality 1401 which provides for editing the E-911 response SMS. The PSAP node 1400 further includes a UE ID, PSAP number and routing information functionality which provides the PSAP E-911 response SMS assembly functionality 1403 with information such as UE ID, PSAP number and routing information. The PSAP E-911 response SMS assembly functionality 1403 provides the assembly of the response SMS which is transmitted to a UE via a routing node.

In an example embodiment the functionalities illustrated in FIG. 13-FIG. 14 may be implemented at least partially on a machine platform including a hardware circuit and/or a computer. The computer-based embodiments comprise a controller or processor executing a set of executable non-transitory instructions stored on computer-readable medium.

In one of its aspects, the technology disclosed herein concerns a positioning node, and particularly a network node that receives a positioning request from a PSAP or a LCS client, where the request may come via intermediate nodes, e.g., PSAP to GMLC to MME to eSMLC, and where the request may contain at least some part of the information, e.g., language capability, contained in the SMS or E-911 SMS transmitted by the UE to PSAP or LCS client. Furthermore, the network node analyses UE capabilities, in particular UE location-related capabilities in order to select and issue positioning activities in order to determine the location of the UE that transmitted the SMS or E-911 SMS. In one exemplary embodiment for non-voice based emergency services, the set of possible positioning methods for the positioning method selection procedure in the positioning node shall be limited to those procedure not relying on voice transmissions.

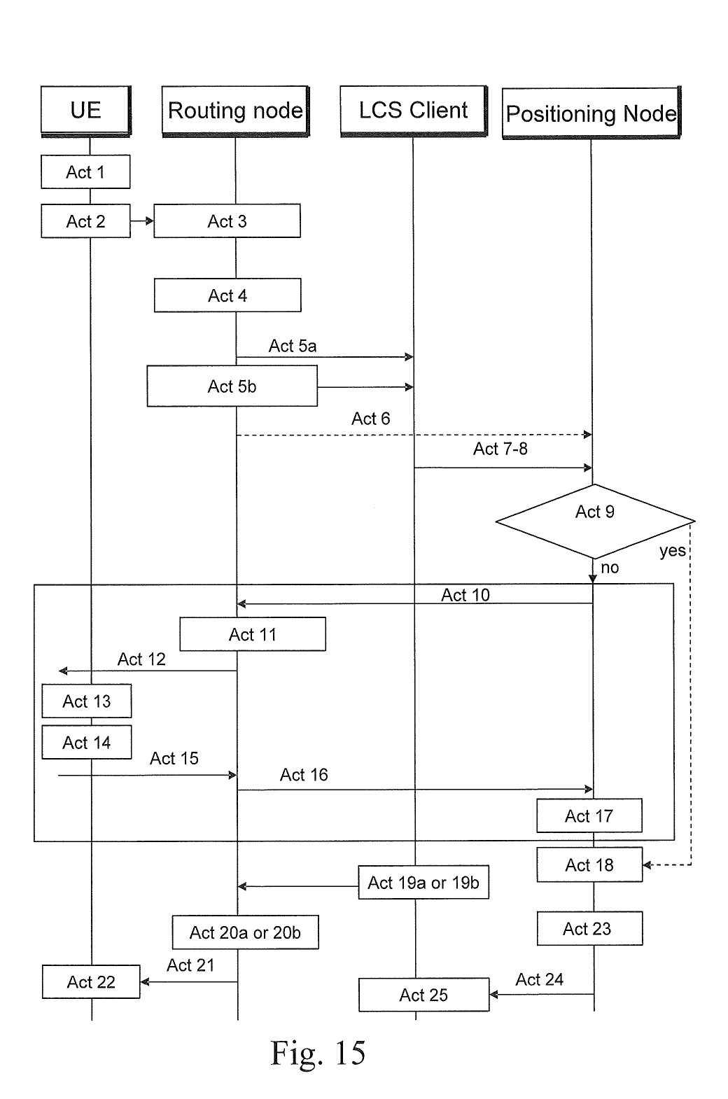

Example embodiments and modes of the system and signalling are described in non-limiting manner below. The technology disclosed encompasses node technology, including the UE, a routing node, a positioning node, e.g., an eSMLC, and a LCS client, e.g. a PSAP. The order of the acts or steps in this example embodiment may be different in other example embodiments and modes. The acts are listed as follows and shown in FIG. 15 illustrating a diagrammatic view of signaling for a text-based message, e.g., an SMS or an E-911 SMS.

Act 1: A UE owner types a text-based message and presses ‘send’.

Act 2: The UE assembles the text-based message, e.g., an SMS or an E-911 SMS, and transfers it to the user plane and sends it over the user plane to the routing node. Optionally, UE capability information is piggy backed.

Act 3: The routing node receives the text-based message over the user plane.

Act 4: In case of emergency positioning, e.g. when the text-based message is an E-911 SMS, the routing node extracts the information and moves the SMS text message to the control plane. In case UE capability information is piggy backed, this information is also moved to the control plane of the routing node. In case of commercial SMS positioning, e.g. when the text-based message is a commercial SMS, the transfer to the control plane is optional. The positioning may then proceed over the user plane. The general ideas of this is similar to the ideas for emergency positioning, but not identical.

Act 5: In case of emergency positioning or commercial SMS positioning when transfer to the control plane is performed, at least one of acts 5a and 5b is executed.

Act 5a: The routing node sends the text-based message, e.g., the E-911 SMS, on to the LCS client, e.g. the PSAP, according to standardized or to be standardized control plane signaling.

Act 5b: The routing node establishes a voice connection to the LCS client, e.g. the PSAP node, and performs a text to speech conversion of the message text of the text-based message and transmits the audio version of the message to the LCS client, e.g. the PSAP.

Act 6: In case of emergency positioning or commercial SMS positioning, and if available in the control plane of the routing node, the UE capability information is sent to the positioning node, e.g., the eSMLC, including UE ID information, i.e. new capability information format is disclosed here since, e.g., the prior-art format associates the capabilities with the session ID but not the UE ID. This requires that the routing node is either configured to know which of control plane and user plane or both that is available or the routing node acquires this information from another network node, e.g., Operation and Maintenance (O&M).

Act 7: The LCS client, e.g. the PSAP, sends a positioning request of the UE, e.g. a phase 2 E-911 positioning request, to the positioning node, e.g. the eSMLC.

Act 8: The positioning node, e.g. the eSMLC receives the positioning request of the UE, e.g. phase 2 E-911 positioning request, from the LCS client, e.g. the PSAP.

Act 9: The positioning node, e.g. the eSMLC, investigates if UE capability information, in particular UE location-related capability, is available. If available, the signalling proceeds with act 18.

Act 10: In one embodiment, the positioning node, e.g. the eSMLC, sends a request for UE capability information to the UE via the routing node. In other embodiments, the request can be sent over the control plane, or directly over the user plane, bypassing this routing node.

Act 11: The routing node transfers the request for UE capability information from the control plane to the user plane.

Act 12: The routing node sends the request for UE capability information to the UE over the user plane.

Act 13: The UE receives the request for UE capability information on the user plane.

Act 14: The UE retrieves the requested information and transfers it to the user plane.

Act 15: The UE sends the UE capability information to the positioning node, e.g. the eSMLC, over the user plane, via the routing node. The UE knows that the text-based message, e.g. the E-911 SMS, is related to the text-based message connection, e.g. the E-911 SMS connection, and therefore also adds the needed routing information.

Act 16: The routing node receives the UE capability information over the user plane, transfers it to the control plane, and sends it on to the positioning node, e.g. the eSMLC. Act 17: The positioning node, e.g. the eSMLC, receives and stores the UE capability information of the UE.

Act 18: The positioning node, e.g. the eSMLC, initiates positioning, e.g. E-911 phase 2 positioning, according to standard procedures, accounting for the UE capability.

Act 19: One of acts 19a or 19b is executed where:

Act 19a: The operator of the LCS client, e.g. the PSAP operator, types a response text-based message, e.g. an E-911 response message, and replies. The LCS client, e.g. the PSAP, sends the response text-based message, e.g. the E-911 response SMS, back to the routing node.

Act 19b: The operator of the LCS client, e.g. the PSAP operator, provides an oral reply i.e. an audio version of the response text-based message to the routing node with pre-defined oral procedures, e.g. oral E-911 procedures.

Act 20: One of acts 20a or 20b is executed where:

Act 20a: The routing node receives the response text-based message, e.g. the E-911 response SMS, over the control plane and transfers it to the user plane.

Act 20b: The routing node receives the oral reply, i.e. an audio version of the response text-based message, over the control plane. Furthermore, the routing node performs a speech to text conversion, and then transfers the text version of the oral reply to the user plane. A response text-based message, e.g. an E-911 response SMS, is assembled at the user plane side of the routing node.

Act 21: The response text-based message, e.g. the E-911 response SMS, is sent to the UE from the routing node to the UE over the user plane. Act 22: The UE receives the response text-based message, e.g. the E-911 response SMS, transfers it to the SMS functional parts, and displays it on the UE display.

Act 23: The positioning node, e.g. the eSMLC, receives information that allows it to produce a location of the UE, e.g. a phase 2 E-911 location. Act 24: The positioning node, e.g. the eSMLC, sends the location of the UE, e.g. the phase 2 E-911 location, to the LCS client, e.g. the PSAP. Standard control plane procedures are used.

Act 25: The LCS client, e.g. the PSAP, receives the location of the UE, e.g. the phase 2 E-911 location. Standard control plane procedures are used.

In one embodiment the text to speech conversion may be performed in the UE instead of the routing node. In this embodiment, in the Act 5b the UE establishes a voice connection to the LCS client, e.g. the PSAP node, via the routing node. The UE performs a text to speech conversion of the message text of the text-based message and thereupon transmits the audio version of the message to the LCS client, e.g. the PSAP, via the routing node. Additionally, the Act 20b is performed in the UE instead of the routing node. The UE receives the oral reply, i.e. an audio version of the response text-based message, over the control plane from the LCS client, e.g. the PSAP. Furthermore, the UE performs a speech to text conversion, and transfers the text version of the oral reply to the user plane of the UE. A response text-based message, e.g. an E-911 response SMS, is assembled at the user plane side of the UE and displayed to the user of the UE.

A general case is similar to the description for the emergency case, but where the functionality of the PSAP is replaced either by a positioning service provider node, which may be, e.g., a commercial location service node such as a LCS client or a commercial service node in general. The general-case embodiments are obtained by removal of “E-911” and “emergency” in the detailed description of the emergency case, and by replacement of the PSAP by a commercial service provider node or non-emergency service, e.g., network management, node.

In the general case the E-911 functionality of the UE that initiates the SMS positioning session previously described is replaced by a commercial SMS based positioning functionality. Any UE requirements hence need to address this difference. SMS should be interpreted in a general broad sense herein.

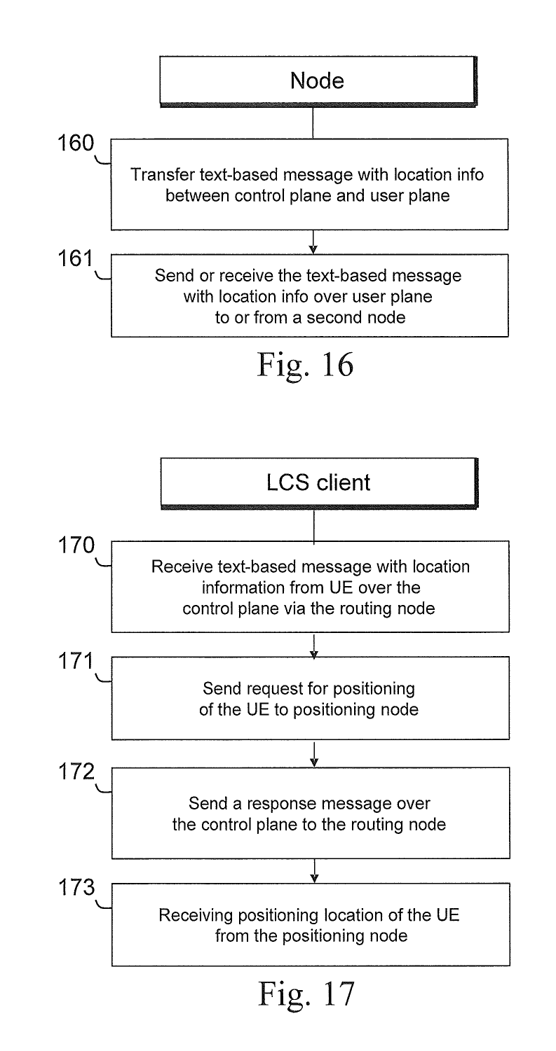

FIG. 16 is a flowchart illustrating an exemplary embodiment of a method in a first node of a wireless communication system, of supporting positioning of a UE. The first node may be a UE or a routing node. In a first step 160 a text-based message with location information, e.g. a SMS, a commercial message, an emergency message, E-911 SMS etc., is transferred between the control plane and the user plane of the first node. In one embodiment the text-based message may be pre-configured. In a second step 161 the text-based message with location information is sent or received over the user plane to or from a second node of the wireless communication system. The second node may be a routing node or a UE.

In an exemplary embodiment, a response message is received or sent over the user plane from or to the second node of the wireless communication system. The response message may be for example, a SMS, a commercial message, an emergency response message etc. The response message is transferred between the user plane and the control plane of the first node.

In a further exemplary embodiment, a text to speech conversion of the text-based message with location information into an audio version of the text-based message is performed in the first node. In the embodiment where the first node is a UE and the second node is a routing node, the method may further comprise a step of establishing a voice connection with the routing node, and a step of sending the audio version of the message to the routing node. In the embodiment where the first node is a routing node and the second node is a UE, the method may further comprise a step of establishing a voice connection with the LCS client, and a step of sending the audio version of the message to the LCS client.

In yet a further exemplary embodiment, where the first node receives an audio version of the response message the method additionally may perform a speech to text conversion of the audio version of the response message into a text-based version of the response message and thereupon assemblies the response message.

In an exemplary embodiment the UE location capability information is not piggybacked with the text-based message and therefore the information is requested by the positioning node and consequently a request for the UE location capability information is received in the first node. Thereupon the node sends the UE location capability information to the positioning node.

In an exemplary embodiment the first node is a routing node and the second node is a UE. The routing node further communicates with a LCS client comprised in the wireless communication system. The method comprises a step of retrieving routing information from the text-based message and thereupon in a further step sending the text-based message over the control plane to the LCS client in accordance with the retrieved routing information. When the routing node receives a response message from the LCS client it is received over the control plane.

FIG. 17 is a flowchart illustrating an exemplary embodiment of a method in a LCS client of a wireless communication system, of supporting positioning of a UE controlled by a routing node comprised in the wireless communication system. The positioning is managed by a positioning node comprised in the wireless communication system. In a first step 170 a text-based message with location information, e.g. a SMS, a commercial message, an emergency message, E-911 SMS etc., is received from the UE over the control plane via the routing node. In a next step 171 a request for a positioning of the UE is sent to the positioning node. Moreover, a response message is sent over the control plane to the routing node in step 172. The positioning node sends a positioning location of the UE which is received in a step 173 by the LCS client.

In an exemplary embodiment a text to speech conversion of the text-based message with location information into an audio version of the text-based message is performed in the routing node. The LCS client establishes a voice connection with the routing node to be able to receive the audio version of the message from the routing node.

In yet a further exemplary embodiment, the LCS client sends an oral reply to the UE via the routing node, i.e. the response message is an audio version of the response message. The UE or the routing node may then perform speech to text conversion of the audio version of the response message as previously described.

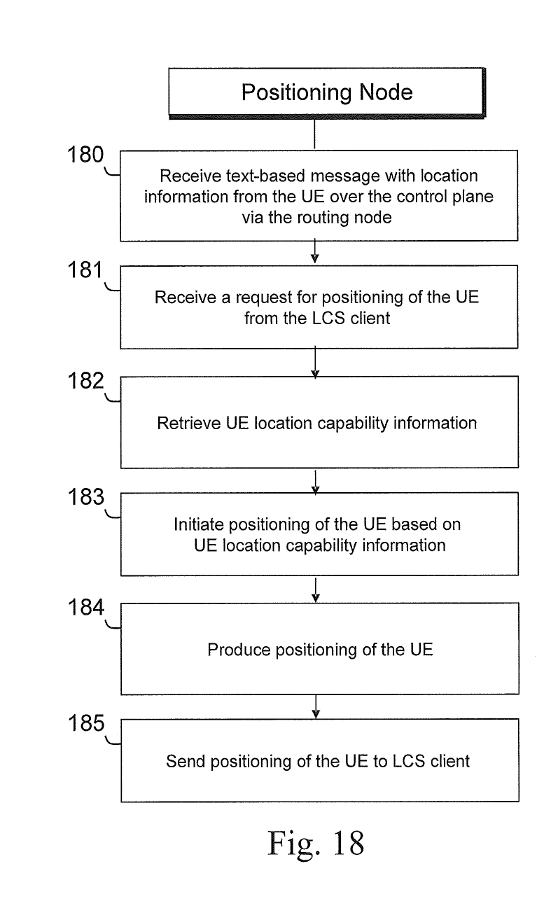

FIG. 18 is a flowchart illustrating an exemplary embodiment of a method in a positioning node of a wireless communication system, of supporting positioning of a UE associated with a location services, LCS, client comprised in the wireless communication system. In a first step 180 a text-based message with location information is received from the UE over the control plane via the routing node. In a further step 181 a request for a positioning of the UE is received from the LCS client. Thereupon, the positioning node retrieves UE location capability information in a step 182. The positioning node initiates positioning of the UE based on the UE location capability information in step 183 and produces the positioning in step 184. In step 185 the positioning of the UE is sent to the LCS client. The UE capability information may be retrieved from the text-based message with location information. However, the positioning node may in an exemplary embodiment explicitly send a request for the UE capability information and routing information to the UE or the routing node and thereupon receive the UE capability information and routing information from the UE or the routing node with the text-based message. In an exemplary embodiment the request for a positioning of the UE may be a request for a phase 2 positioning of the UE.

It should be pointed out that the mentioned step 181 of receiving a request may in another exemplary embodiment precede the step 180 of receiving the text-based message.

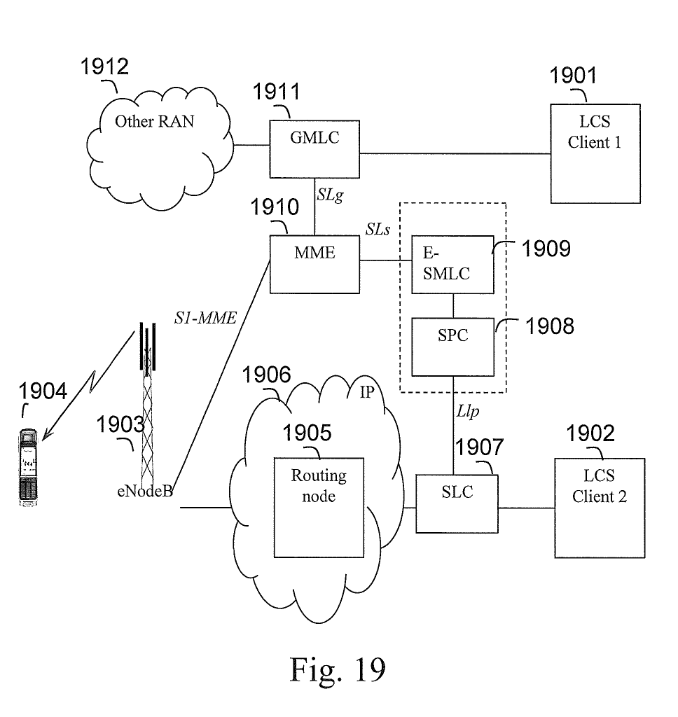

FIG. 19 shows an example network diagram. Location Services (LCS) Client 1 denoted 1901 is an example entity which may reside in PSAP and Location Services (LCS) Client 2 denoted 1902 is an example entity which may reside in a commercial service node. The illustrated connections are either direct connections or connections via one or more other nodes. LCS clients may be one of those already described herein. In the exemplary network diagram an eNodeB 1903 is illustrated which serves a plurality of UEs 1904 (only one UE is shown). The network further comprises a routing node 1905 included in an IP network 1906, a SLC 1907, a SPC 1908, an eSMLC 1909, a MME 1910, a GMLC 1911 with is connected to other RAN 1912.

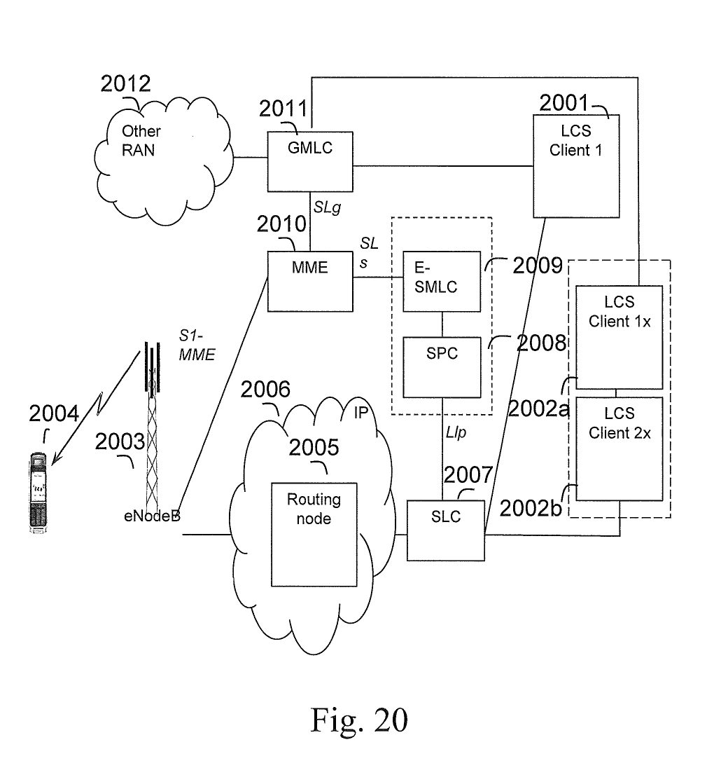

FIG. 20 shows another network diagram wherein a new connection and/or interface is added in the node with LCS Client 1 denoted 2001 to enable its communication with SLC 2007 or the router 2005 (via SLC). Alternatively, LCS Client 1× denoted 2002a and LCS Client 2× denoted 2002b may communicate with each other or in a special case be co-located and have a proprietary interface. Both alternatives are illustrated in FIG. 20. The illustrated connections are either direct connections or connections via one or more other nodes. LCS clients may be one of those already described herein. In the exemplary network diagram an eNodeB 2003 is illustrated which serves a plurality of UEs 2004 (only one UE is shown). The network further comprises the routing node 2005 included in a IP network 2006, a SLC 2007, a SPC 2008, an eSMLC 2009, a MME 2010, a GMLC 2011 with is connected to other RAN 2012.

It has been mentioned that one or more of the nodes including the UE may be implemented at least partially on a machine platform including a hardware circuit and/or a computer. In this context the terminology “platform” is a way of describing how the functional units of a node can be implemented or realized by machine. In one example embodiment at least some constituent members of the platform are realized by one or more processors which execute coded instructions and use non-transitory signals in order to perform the various acts described herein. In such a computer implementation the node may comprise, in addition to a processor(s), a memory section (which in turn may comprise a random access memory; a read only memory; an application memory (which stores, e.g., coded instructions which can be executed by the processor to perform acts described herein); and any other memory such as cache memory, for example). Typically the platform of a node also comprises other input/output units or functionalities, such as a keypad; an audio input device, e.g., microphone; a visual input device, e.g., camera; a visual output device; and an audio output device, e.g., speaker. Other types of input/output devices can also be connected to or comprise the station node.

The following are exemplary, non-limiting and non-exhaustive features of the technology disclosed herein which concern, e.g., a UE. The features are switch determining between control plane/user plane E-911 SMSing, UE internal control plane/user plane interface, E-911 SMS transmission over the user plane, E-911 response SMS reception over the user plane, transfer of UE capability information to the user plane, which may include UE ID, signaling of UE capability information over the user plane from the UE to the routing node, and reception of UE capability request over the user plane via the router node.

The following are exemplary, non-limiting and non-exhaustive features of the technology disclosed herein which concern, e.g., a routing node. The features are routing node internal interface allowing transfer of information and routing information between the user plane and control plane for E-911 positioning, transfer of E-911 SMS from the user plane to the control plane, transfer of E-911 from the user plane to the control plan, followed by E-911 call setup, text to speech conversion and audio transmission to the PSAP, transfer of E-911 response SMS from the control plane to the user plane, speech to text conversion of E-911 response from PSAP, transfer of text information to the user plane, and assembly of E-911 response SMS, transfer of UE capability information from the user plane to the control plane, transfer of UE capability request from the control plane to the user plane, reception of E-911 SMS from the UE on the user plane, transmission of E-911 response SMS to the UE on the user plane, transmission of E-911 SMS to the PSAP on the control plane, reception of E-911 SMS from the PSAP on the control plane, reception of E-911 SMS with UE capability information piggy backed on the user plane, new procedures for transmission of UE capability information to the eSMLC, new procedures for reception of UE capability request from the eSMLC, transmission of UE capability information request on the user plane, and language translation.

The following are exemplary, non-limiting and non-exhaustive features of the technology disclosed herein which concern, e.g., an eSMLC node. The features are new procedures for transmission of UE capability request to be routed over the user plane, and new procedures for reception and temporary storage of UE capability information routed over the user plane.

The following are exemplary, non-limiting and non-exhaustive features of the technology disclosed herein which concern, e.g., a PSAP node. The features are reception of E-911 SMS with signaling to be standardized over the control plane, creation of E-911 response SMS, e.g., an editor, transmission of E-911 response SMS with signaling to be standardized over the control plane, including of location information into the response message, and operating and signaling at least one new Client Type and/or one new Service Class to enable non-voice emergency service.

The following are exemplary, non-limiting and non-exhaustive features of the technology disclosed herein which concern, e.g., user plane signaling. The features are UE capability request, UE capability information, E-911 SMS, E-911 SMS with piggy backed UE capability information, in particular UE location-related capability information, and E-911 response SMS.

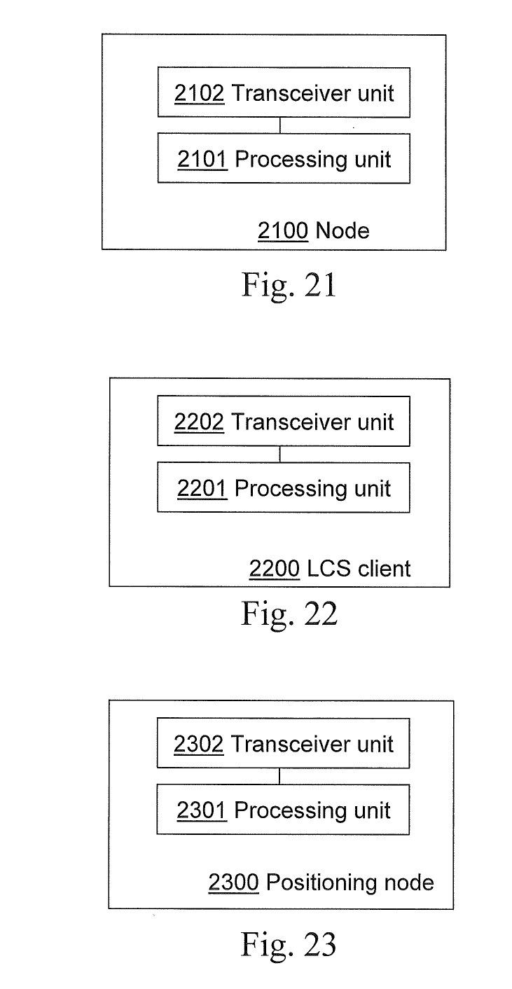

FIG. 21 is a block diagram of an exemplary embodiment of an arrangement in a first node 2100 of a wireless communication system, for supporting positioning of a UE. The arrangement comprises a processing unit 2101 adapted to transfer a text-based message with location information between the control plane of the first node and the user plane of the first node. The arrangement further comprises a transceiver unit 2101 adapted to send or receive the text-based message with location information over the user plane to or from a second node of the wireless communication system. The text-based message with location information may be an emergency message and may also be pre-configured. In another exemplary embodiment the processing unit 2101 is further adapted to perform text to speech conversion of the text-based message with location information into an audio version of the text-based message.

In one exemplary embodiment the transceiver unit 2102 if further adapted to receive or send a response message over the user plane from or to the second node of the wireless communication system, and the processing unit 2101 is further adapted to transfer the response message between the user plane to the control plane of the first node. The received response message may be an audio version of the response message whereupon the processing unit 2101 is adapted to perform speech to text conversion of the audio version of the response message into a text-based version of the response message. Moreover, the processing unit 2101 is adapted to assemble the response message.

In yet an exemplary embodiment the transceiver unit 2102 is adapted to receive a request for UE capability information and to send the UE capability information.

In an exemplary embodiment the first node is a UE and the second node is a routing node. The processing unit 2101 may be adapted to establish a voice connection with the routing node and the transceiver unit 2102 may then be adapted to send the audio version to the routing node.

In another exemplary embodiment the first node 2100 is a routing node and the second node is a UE. The processing unit 2101 of the routing node may be adapted to retrieve routing information from the text-based message, and the transceiver unit 2102 of the routing node may be adapted to send the text-based message over the control plane to a LCS client in accordance with the retrieved routing information. Additionally, the transceiver unit 2102 may be adapted to receive the response message over the control plane from the LCS client in such an embodiment.

In an exemplary embodiment wherein the LCS client sends an oral reply the processing unit 2101 of the routing node may be adapted to establish a voice connection with the LCS client.

FIG. 22 is a block diagram of an exemplary embodiment of an arrangement in an LCS client 2200 of a wireless communication system for supporting positioning of a UE. The UE is controlled by a routing node which is also comprised in the wireless communication system. The arrangement comprises a transceiver unit 2202 adapted to receive a text-based message with location information from the UE over the control plane via the routing node. The transceiver unit 2202 is further adapted to send a request for positioning of the UE to a positioning node comprised in the wireless communication system and receive a positioning location of the UE from the positioning node. Moreover, the transceiver unit 2202 is further adapted to send a response message over the control plane to the routing node.

In an exemplary embodiment, a processing unit 2201 comprised in the arrangement in the LCS client 2200 may be adapted to establish a voice connection with the routing node. Furthermore, the transceiver unit 2202 may be adapted to send an audio version of the response message to the routing node.

FIG. 23 is a block diagram of an exemplary embodiment of an arrangement in a positioning node 2300 of a wireless communication system, for supporting positioning of a UE. The UE is associated with an LCS client comprised in the wireless communication system. The UE is controlled by a routing node also comprised in the wireless communication system. The arrangement comprises a transceiver unit 2302 adapted to receive a text-based message with location information from the UE over the control plane via the routing node. Furthermore it is adapted to receive a request for a positioning of the UE from the LCS client. The arrangement also comprises a processing unit 2301 adapted to retrieve UE location capability information. The processing unit 2301 is further adapted to initiate positioning of the UE based on the UE location capability information and to produce positioning of the UE. Moreover, the transceiver unit 2302 is also adapted to send positioning of the UE to the LCS client.

In an exemplary embodiment, the UE capability information is retrieved from the text-based message with location information.

In yet another embodiment the transceiver unit 2302 is adapted to send a request for the UE capability information and routing information to the LCS client, and to receive the UE capability information and routing information from the LCS client.

The following are example, non-limiting technical advantages realized through the technology disclosed herein.

Non-voice communication means, e.g., SMS or other messaging service, become a part of the communication media that can be used between UE and PSAPs for stealthy E-911 positioning which, firstly, allow users with speech disabilities to contact PSAPs and get the emergency service, including positioning which is normally conducted for E-911 calls. Secondly, they allow users to contact PSAPs in threatening situations without getting detected due to audio traffic. Thirdly, they allow users to be positioned in threatening situations without getting detected due to audio traffic. Finally, they allow users without any voice connection, e.g., users using laptops, to be positioned in threatening situations.

Means for inter-working between the user plane and control plane become available to enable non-voice emergency services, which allows for flexible user-plane solutions with a possibility to access the emergency service provided by the network.

Abbreviations

3GPP 3^{rd} Generation Partnership Project

A-GPS Assisted GPS

BS Base Station

eNodeB evolved Node B

EPC Evolved Packet Core

eSMLC Evolved SMLC

GMLC Gateway Mobile Location Center

GPS Global Positioning System

HLR Home Location Register

LPP LTE Positioning Protocol

LPPa LPP Annex

LTE Long-Term Evolution

MSC Mobile services Switching Centre

OTDOA Observed Time Difference Of Arrival

PRS Positioning Reference Signal

PSAP Public Safety Answer Point

RAN Radio Access Network

RAT Radio Access Technology

RB Resource Block

RRC Radio Resource Control

SET SUPL-Enabled Terminal

SGSN Serving GPRS Support Node

SMLC Serving Mobile Location Center

SUPL Secure User Plane Location protocol

TA Timing Advance

UE User Equipment

UMTS Universal Mobile Telecommunications System

VMSC Visited Mobile services Switching Centre

Although the description above contains many specificities, these should not be construed as limiting the scope of the invention but as merely providing illustrations of some of the presently preferred embodiments. It will be appreciated that the scope of the present embodiments fully encompasses other embodiments which may become obvious to those skilled in the art, and that the scope of the present embodiments is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the present disclosure, for it to be encompassed hereby.

1. A method in a first node of a wireless communication system, of supporting positioning of a user equipment, UE, the method comprising:
transferring a text-based message with location information between the control plane of the first node and the user plane of the first node; and
sending or receiving the text-based message with location information over the user plane to or from a second node of the wireless communication system.

2. The method according to claim 1, further comprising:
receiving or sending a response message over the user plane from or to the second node of the wireless communication system,
transferring the response message between the user plane to the control plane of the first node.

3. The method according to claim 1, wherein the text-based message with location information is an emergency message.

4. The method according to claim 1, wherein the text-based message with location information is pre-configured.

5. The method according to claim 1, further comprising
performing text to speech conversion of the text-based message with location information into an audio version of the text-based message.

6. The method according to claim 1, wherein received response message is an audio version of the response message, the method further comprising:
performing speech to text conversion of the audio version of the response message into a text-based version of the response message,
assembling the response message.

7. The method according to claim 1, further comprising
receiving a request for UE capability information,
and
sending the UE capability information.

8. The method according to claim 1, wherein the first node is a UE and the second node is a routing node.

9. The method according to claim 8, further comprising:
establishing a voice connection with the routing node, and wherein the audio version is sent to the routing node.

10. The method according to claim 1, wherein the first node is a routing node and the second node is a UE.

11. The method according to claim 10, wherein the routing node can communicate with a location services, LCS, client comprised in the wireless communication system, the method comprising:
retrieving routing information from the text-based message,
sending the text-based message over the control plane to the LCS client in accordance with the retrieved routing information,
receiving the response message over the control plane from the LCS client.

12. The method according to claim 10, further comprising
establishing a voice connection with the LCS client.

13. A method in a location services, LCS, client of a wireless communication system, of supporting positioning of a user equipment, UE, controlled by a routing node comprised in the wireless communication system, the method comprising:
receiving a text-based message with location information from the UE over the control plane via the routing node,
sending a request for positioning of the UE to a positioning node comprised in the wireless communication system,
sending a response message over the control plane to the routing node; and
receiving a positioning location of the UE from the positioning node.

14. The method according to claim 13, further comprising
establishing voice connection with the routing node.

15. The method according to claim 13, wherein the response message is an audio version of the response message.

16. A method in a positioning node of a wireless communication system, of supporting positioning of a user equipment, UE, associated with a location services, LCS, client comprised in the wireless communication system, the UE being controlled by a routing node comprised in the wireless communication system, the method comprising:
receiving a text-based message with location information from the UE over the control plane via the routing node,
receiving a request for a positioning of the UE from the LCS client,
retrieving UE location capability information,
initiating positioning of the UE based on the UE location capability information,
producing positioning of the UE; and
sending positioning of the UE to the LCS client.

17. The method according to claim 16, wherein the UE capability information is retrieved from the text-based message with location information.

18. The method according to claim 16, wherein the request is a request for a phase 2 positioning.

19. The method according to claim 16, further comprising
sending a request for the UE capability information and routing information to the UE or the routing node,
receiving the UE capability information and routing information from the UE or the routing node.

20. An arrangement in a first node of a wireless communication system, of supporting positioning of a user equipment, UE, the arrangement comprises
a processing unit adapted to transfer a text-based message with location information between the control plane of the first node and the user plane of the first node, and
a transceiver unit adapted to send or receive the text-based message with location information over the user plane to or from a second node of the wireless communication system.

21. The arrangement according to claim 20, wherein the transceiver unit if further adapted to receive or send a response message over the user plane from or to the second node of the wireless communication system, and the processing unit is further adapted to transfer the response message between the user plane to the control plane of the first node.

22. The arrangement according to claim 20, wherein the text-based message with location information is an emergency message.

23. The arrangement according to claim 20, wherein the text-based message with location information is pre-configured.

24. The arrangement according to claim 20, wherein the processing unit is further adapted to perform text to speech conversion of the text-based message with location information into an audio version of the text-based message.

25. The arrangement according to claim 20, wherein received response message is an audio version of the response message, the processing unit is further adapted to perform speech to text conversion of the audio version of the response message into a text-based version of the response message and to assemble the response message.

26. The arrangement according to claim 20, wherein the transceiver unit is further adapted to receive a request for UE capability information, and to send the UE capability information.

27. The arrangement according to claim 20, wherein the first node is a UE and the second node is a routing node.

28. The arrangement according to claim 27, wherein the processing unit is further adapted to establish a voice connection with the routing node, and wherein the transceiver unit is adapted to send the audio version to the routing node.

29. The arrangement according to claim 20, wherein the first node is a routing node and the second node is a UE.

30. The arrangement according to claim 29, wherein the routing node is configured to communicate with a location services, LCS, client comprised in the wireless communication system, the processing unit is adapted to retrieve routing information from the text-based message, and the transceiver unit is adapted to send the text-based message over the control plane to the LCS client in accordance with the retrieved routing information, and to receive the response message over the control plane from the LCS client.

31. The arrangement according to claim 29, wherein the processing unit is further adapted to establish a voice connection with the LCS client.

32. An arrangement in a location services, LCS, client of a wireless communication system, of supporting positioning of a user equipment, UE, controlled by a routing node comprised in the wireless communication system, the arrangement comprises
a transceiver unit adapted to
receive a text-based message with location information from the UE over the control plane via the routing node,
send a request for positioning of the UE to a positioning node comprised in the wireless communication system,
send a response message over the control plane to the routing node; and
receive a positioning location of the UE from the positioning node.

33. The arrangement according to claim 32, further comprises a processing unit adapted to establishing voice connection with the routing node.

34. The arrangement according to claim 32, wherein the response message is an audio version of the response message.

35. An arrangement in a positioning node of a wireless communication system, of supporting positioning of a user equipment, UE, associated with a location services, LCS, client comprised in the wireless communication system, the UE is configured to be controlled by a routing node comprised in the wireless communication system, the arrangement comprises
a transceiver unit adapted to
receive a text-based message with location information from the UE over the control plane via the routing node,
receive a request for a positioning of the UE from the LCS client, and further comprises
a processing unit adapted to
retrieve UE location capability information,
initiate positioning of the UE based on the UE location capability information,
produce positioning of the UE, and the transceiver unit is further adapted to
send positioning of the UE to the LCS client.

36. The arrangement according to claim 35, wherein the UE capability information is retrieved from the text-based message with location information.

37. The arrangement according to claim 35, wherein the request is a request for a phase 2 positioning.

38. The arrangement according to claim 35, wherein the transceiver unit is further adapted to
send a request for the UE capability information and routing information to the UE or the routing node, and
receive the UE capability information and routing information from the UE or the routing node.
